(19) United States
(12) Patent Application Publication
(10) Pub. No.: US 2012/0052370 A1
(43) Pub. Date: Mar. 1, 2012

(54) Rechargeable battery

(76) Inventor: Jong-Seok Moon, Yongin-si (KR)

(21) Appl. No.: 12/929,581

(22) Filed: Feb. 2, 2011

(30) Foreign Application Priority Data
Aug. 31, 2010 (KR) 10-2010-0084839

(51) Int. Cl. H01M 2/02

(52) U.S. Cl. 429/179

(57) ABSTRACT

A rechargeable battery including an electrode assembly including a positive electrode and a negative electrode on surfaces of a separator; a case accommodating the electrode assembly, the case including an opening at one end thereof; a cap plate closing the opening of the case, the cap plate including a terminal hole therethrough; an electrode terminal in the terminal hole of the cap plate; and a nut screw-coupled to the electrode terminal outside of the case, wherein the nut includes a first gripping portion extending toward the cap plate, the first gripping portion being configured to prevent releasing of the nut in a reversed fastening direction, and being supported on the cap plate.

### BACKGROUND

1. Field

Embodiments relate to a rechargeable battery.

2. Description of the Related Art

A rechargeable battery may include an electrode assembly having a jelly roll shape in which a separator and a positive electrode and a negative electrode on both surfaces of the separator are wound. The rechargeable battery may further include a case housing or accommodating the electrode assembly, a cap plate sealing an opening of the case, and an electrode terminal electrically connected to the electrode assembly.

For example, the electrode terminal may be connected to each of the positive electrode and the negative electrode of the electrode assembly through a lead tab in the case and may protrude outwardly from the cap plate through a terminal hole in the cap plate. The electrode terminal may include a bolt portion outside of the cap plate.

A gasket may be interposed between the electrode terminal and the terminal hole; and an insulator may be installed between the lead tab and the cap plate. In addition, the electrode terminal may be fastened to a nut outside of the cap plate to be installed in the terminal hole of the cap plate.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a rechargeable battery.

At least one of the above and other features and advantages may be realized by providing a rechargeable battery including an electrode assembly including a positive electrode and a negative electrode on surfaces of a separator; a case accommodating the electrode assembly, the case including an opening at one end thereof; a cap plate closing the opening of the case, the cap plate including a terminal hole therethrough; an electrode terminal in the terminal hole of the cap plate; and a nut screw-coupled to the electrode terminal outside of the case, wherein the nut includes a first gripping portion extending toward the cap plate, the first gripping portion being configured to prevent releasing of the nut in a reversed fastening direction, and being supported on the cap plate.

The first gripping portion may be on a surface of the nut, the surface facing the cap plate.

The cap plate may include a second gripping portion on an outer surface thereof, the second gripping portion facing the first gripping portion.

The first gripping portion and the second gripping portion may each have an uneven structure, the uneven structure of the first gripping portion being coupled with the uneven structure of the second gripping portion.

The first gripping portion and the second gripping portion may each have a sawtooth structure, the sawtooth structure of the first gripping portion being coupled with the sawtooth structure of the second gripping portion.

A first width of the sawtooth of the first gripping portion may be formed in a fan shape outside of a screw hole of the nut, and a second width of the sawtooth of the second gripping portion may be formed in a fan shape outside of the terminal hole.

The first gripping portion and the second gripping portion may have complementary structures, the complementary structures of the first and second gripping portions being interengaged with one another.

The first gripping portion may have a first width in a radial direction thereof, the second gripping portion may have a second width in a radial direction thereof, and the second width may be greater than the first width.

The first gripping portion may include a first insulating layer on a surface thereof that faces the second gripping portion, the first insulating layer including one of an anodized oxide layer or a coated synthetic resin layer.

The second gripping portion may include a second insulating layer on a surface thereof that faces the first gripping portion, the second insulating layer including one of an anodized oxide layer or a coated synthetic resin layer.

The rechargeable battery may further include an insulator in the terminal hole, wherein the insulator includes a cylindrical portion interposed between an inner surface of the terminal hole and the electrode terminal, and a flange portion extending from the cylindrical portion and interposed between an inner surface of the cap plate and the lead tab, a top of the cylindrical portion may extend toward the second gripping portion, and the first gripping portion may be coupled to the second gripping portion and to the top of the cylindrical portion.

The rechargeable battery may further include a top plate having a through-hole aligned with the terminal hole, the top plate being coupled to an outer surface of the cap plate and closely contacting the nut.

The top plate may include a second gripping portion on an outer surface thereof, the second gripping portion facing the first gripping portion.

The first gripping portion and the second gripping portion may each have a sawtooth structure, the sawtooth structure of the first gripping portion being coupled with the sawtooth structure of the second gripping portion.

A first width of the sawtooth of the first gripping portion may be formed in a fan shape outside of a screw hole of the nut, and a second width of the sawtooth of the second gripping portion may be formed in a fan shape outside of the through-hole of the top plate.

The first gripping portion and the second gripping portion may have complementary structures, the complementary structures of the first and second gripping portions being interengaged with one another.

The first gripping portion may have a first width in a radial direction thereof, the second gripping portion may have a second width in a radial direction thereof, and the second width may be greater than the first width.

The first gripping portion may include a first insulating layer on a surface thereof that faces the second gripping portion, the first insulating layer including one of an anodized oxide layer or a coated synthetic resin layer.

The second gripping portion may include a second insulating layer on a surface thereof that faces the first gripping portion, the second insulating layer including one of an anodized oxide layer or a coated synthetic resin layer.

The rechargeable battery may further include insulator in the terminal hole, wherein the insulator may include a cylindrical portion interposed between the electrode terminal and an inner surface of the terminal hole and between the electrode terminal and an inner surface of the through-hole of the top plate, and a flange portion extending from the cylindrical portion and interposed between an inner surface of the cap plate and the lead tab, a top of the cylindrical portion may extend toward the second gripping portion, and the first gripping portion may be coupled to the second gripping portion and to the top of the cylindrical portion.

### BRIEF DESCRIPTION OF THE DRAWINGS

Features and advantages will become more apparent to those of ordinary skill in the art by describing in detail exemplary embodiments with reference to the attached drawings, in which:

FIG. 1 illustrates a perspective view of a rechargeable battery according to an embodiment.

FIG. 2 illustrates a cross-sectional view taken along line II-II of FIG. 1.

FIG. 3 illustrates an exploded perspective view of an electrode terminal, a cap plate, and a lead tab of the rechargeable battery of FIG. 1.

FIG. 4 illustrates an enlarged perspective view of an outer surface of the cap plate and a bottom of a nut of FIG. 3.

FIG. 5 illustrates a cross-sectional view taken along line V-V of FIG. 3.

FIG. 6 illustrates a coupling state of the outer surface of the cap plate and the bottom of the nut of FIG. 3.

FIG. 7 illustrates a cross-sectional view of a coupling state of an electrode terminal, a cap plate, and a lead tab in a rechargeable battery according to another embodiment.

FIG. 8 illustrates an enlarged perspective view of the cap plate, an outer surface of a top plate, and a bottom of a nut of FIG. 7.

FIG. 9 illustrates a coupling state of the outer surface of the top plate and the bottom of the nut of FIG. 8.

### DETAILED DESCRIPTION

Korean Patent Application No. 10-2010-0084839, filed on Aug. 31, 2010, in the Korean Intellectual Property Office, and entitled: “Rechargeable Battery,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

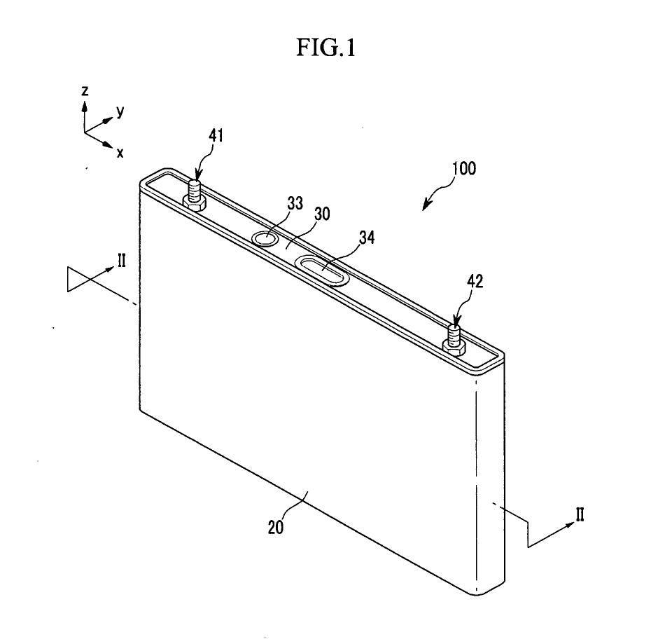

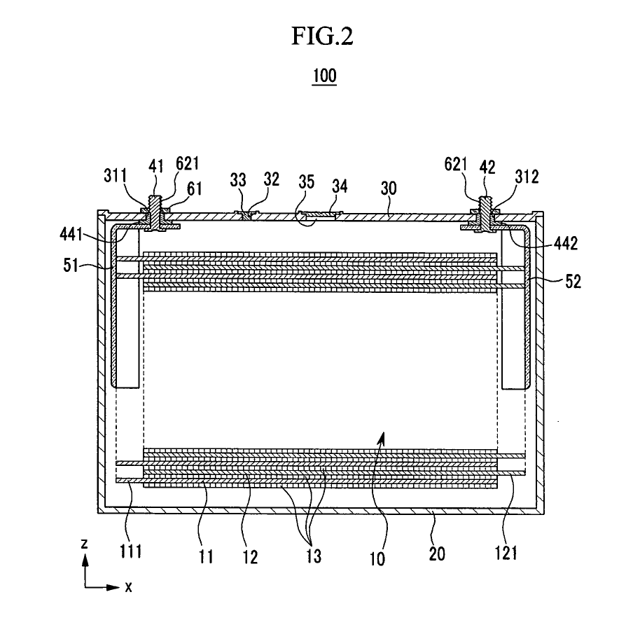

FIG. 1 illustrates a perspective view of a rechargeable battery according to an embodiment. FIG. 2 illustrates a cross-sectional view taken along line II-II of FIG. 1. Referring to FIGS. 1 and 2, the rechargeable battery 100 may include a case 20 accommodating an electrode assembly 10, a cap plate 30 closing an opening at one portion or end of the case 20, electrode terminals 41 and 42 in the cap plate 30, and lead tabs 51 and 52 electrically connecting the electrode terminals 41 and 42 to the electrode assembly 10.

For example, the electrode assembly 10 may include an insulating separator 13 and a positive electrode 11 and a negative electrode 12 on respective surfaces of the separator 13. The electrode assembly 10 may have a jelly roll shape formed by winding the positive electrode 11, the negative electrode 12, and the separator 13 together. In an implementation, the electrode assembly 10 may be assembled by stacking (not illustrated) the positive and negative electrodes 11 and 12, which may be formed by a single metal plate, with the separator 13 interposed therebetween or assembled by bending and stacking the positive electrode 11, the separator 13, and the negative electrode 12 in a zigzag manner (not illustrated).

The positive electrode 11 and the negative electrode 12 may be formed by coating a current collector formed of a thin metal plate with an active material. Accordingly, each of the positive electrode 11 and the negative electrode 12 may include a coated region where the current collector is coated with the active material and uncoated regions 111 and 121 where the current collector is not coated with the active material and is exposed. The coated region may occupy a majority of the area of the positive electrode 11 and the negative electrode 12; and the uncoated regions 111 and 121 may be at sides of the coated region of the electrode assembly 10 in a jelly roll state, respectively.

The case 20 may form an entire exterior of the rechargeable battery 100 and may be made of a conductive metal, e.g., aluminum, an aluminum alloy, and/or nickel-plated steel. The case 20 may include a space accommodating the electrode assembly 10. For example, the case 20 may have a rectangular parallelepiped angular shape having an opening at one side or end thereof to accommodate the electrode assembly 10 having a shape corresponding to the rectangular parallelepiped. The opening may face an upper direction (z-axis direction) in the case 20 shown in FIGS. 1 and 2.

The cap plate 30 may be formed of a thin plate material and may be installed at the opening of the case 20 to seal the case 20. Thus, the cap plate 30 may block an outer part and an inner part of the case 20 from each other and further, as desired, the cap plate 30 may connect the outer part and the inner part to each other.

The cap plate 30 may include components facilitating formation and operation of the rechargeable battery 100, e.g., terminal holes 311 and 312 drawing or exposing the electrode terminals 41 and 42, respectively, an electrolyte injection hole 32 for injecting an electrolyte solution, and a vent hole 35 for ensuring the stability of the rechargeable battery 100 when an internal pressure of the rechargeable battery 100 exceeds a predetermined pressure.

The electrolyte injection hole 32 may facilitate injection of an electrolyte into the case 20 while the cap plate 30 is coupled to the case 20. After the electrolyte is injected into the case 20, the electrolyte injection hole 32 may be sealed with a sealing plug 33.

The vent hole 35 may be sealed with a vent plate 34 so as to maintain a closed state when the rechargeable battery 100 is normally operated and opened when the internal pressure exceeds the predetermined pressure. For example, the vent plate 34 may be made of a plate material that is thinner than the cap plate 30 and may be welded to the circumference of the vent hole 35.

Gas may be generated from an inner part of the rechargeable battery 100 during charging and/or discharging operations of the electrode assembly 10; and the internal gas may increase the internal pressure of the case 20. When the internal pressure of the rechargeable battery 100 exceeds the predetermined pressure, the vent plate 34 may burst or fracture and discharge the gas, thereby preventing explosion of the rechargeable battery 100.

The terminal holes 311 and 312 may facilitate installation of the electrode terminals 41 and 42 through the cap plate 30. For example, the electrode terminals 41 and 42 may be respectively electrically connected to the positive electrode 11 and the negative electrode 12 of the electrode assembly 10 through the terminal holes 311 and 312 to draw or expose the positive electrode 11 and the negative electrode 12 outside of the cap plate 30.

The electrode terminals 41 and 42 may be installed in the terminal holes 311 and 312 with insulators 441 and 442 therebetween to be electrically insulated from the cap plate 30. The insulators 441 and 442 may extend between lead tabs 51 and 52 connected to the electrode terminals 41 and 42 and the cap plate 30 in an inner part of the cap plate 30 to electrically insulate the lead tabs 51 and 52 and the cap plate 30 from each other.

The electrode terminals 41 and 42 connected to the positive electrode 11 and the negative electrode 12 of the electrode assembly 10, respectively, may have the same structure. Therefore, hereinafter, the electrode terminal 42 connected to the negative electrode 12 will not be described; and the electrode terminal 41 connected to the positive electrode 11 will be described.

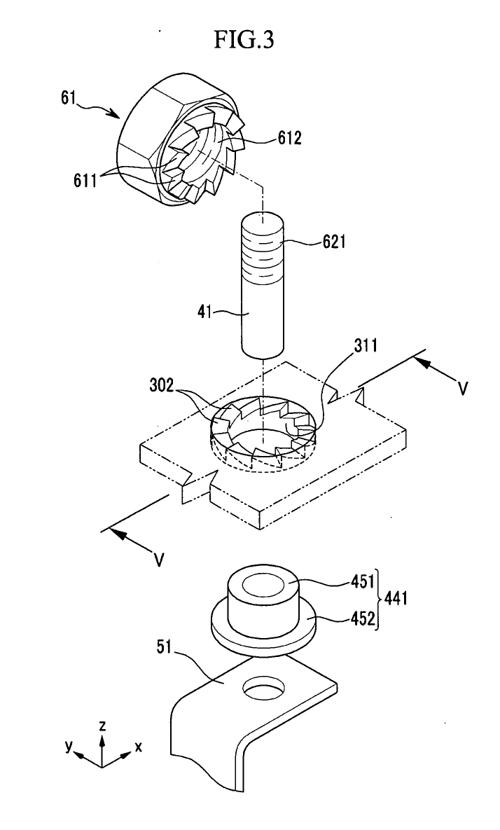

FIG. 3 illustrates an exploded perspective view of an electrode terminal, a cap plate, and a lead tab of the rechargeable battery of FIG. 1. Referring to FIGS. 2 and 3, the electrode terminal 41 may be installed in the terminal hole 311 of the cap plate 30, may be connected to the lead tab 51 by, e.g., caulking, riveting, or welding in the inner part of the cap plate 30, and may be fastened to a bolt portion 621 outside of the cap plate 30 with a nut 61.

For example, the insulator 441 may include a cylindrical portion 451 corresponding to the terminal hole 311 as well as a flange portion 452 that extends in a radial direction from the cylindrical portion 451. The cylindrical portion 451 may be interposed between an inner surface of the terminal hole 311 and an outer surface of the electrode terminal 41 to electrically insulate and seal both parts. The flange portion 452 may be interposed between an inner surface of the cap plate 30 and a top of the lead tab 51 to electrically insulate and seal both parts.

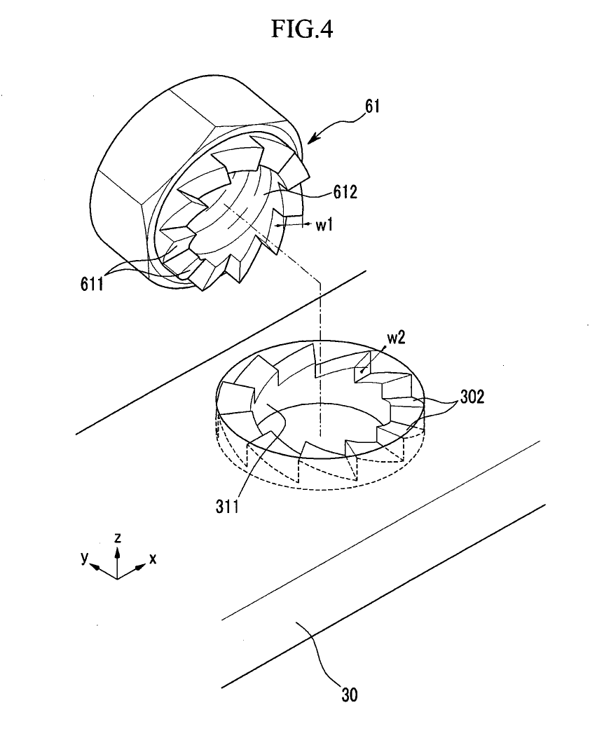

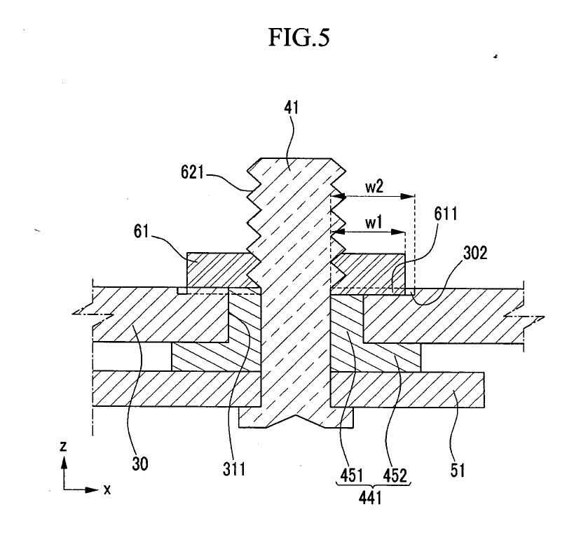

FIG. 4 illustrates an enlarged perspective view of an outer surface of the cap plate and a bottom of a nut of FIG. 3. FIG. 5 illustrates a cross-sectional view taken along line V-V of FIG. 3. Referring to FIGS. 4 and 5, the nut 61 may be fastened to the bolt portion 621. The nut 61 may include a first sticking or gripping portion 611 to prevent release or movement of the nut 61 in a reversed fastening direction, e.g., loosening of the nut 61. For example, the first gripping portion 611 may be formed toward or may face an outer surface of the cap plate 30.

The first gripping portion 611 may be supported on the cap plate 30 while the nut 61 is fastened to the bolt portion 621. Thus, movement of the nut 61 in the reversed fastening-direction rotation may be prevented in spite of elasticity of the insulator 441. For example, weakening of a fastening force between the electrode terminal 41 and the nut 61 may be prevented.

The first gripping portion 611 may be formed on a surface of the nut 61 that faces the cap plate 30. Accordingly, when the nut 61 is fastened to the bolt portion 621 of the electrode terminal 41, the first gripping portion 611 of the nut 61 may closely contact the outer surface of the cap plate 30 with a large frictional force, e.g., a frictional force sufficient to prevent the nut 61 from moving in the reversed fastening direction, e.g., from being released from the bolt portion 621.

A second sticking or gripping portion 301 may be formed on the outer surface of the cap plate 30, e.g., a surface that faces the first gripping portion 611, at the time the cap plate 30 is made. The second gripping portion 301 may be coupled to the first gripping portion 611. For example, the second gripping portion 301 may be interengaged with the first gripping portion 611. Therefore, when the nut 61 is fastened to the bolt portion 621 of the electrode terminal 41, the first gripping portion 611 may be coupled to and supported on the second gripping portion 301 to securely fix a position of the nut 61 and to prevent the nut 61 from moving in the reverse fastening direction, e.g., from being released from the bolt portion 621. For example, the first gripping portion 611 and the second gripping portion 301 may have complementary structures and the complementary structures of the first and second gripping portions 611 and 301 may be interengaged with one another.

For example, the first and second gripping portions 611 and 301 may have an uneven structure and may be coupled to or interengaged with each other. For example, the first and second gripping portions 611 and 301 may respectively include sawteeth that may be coupled to or interengage with each other. Such a sawteeth coupling structure of the first and second gripping portions 611 and 301 may prevent the nut 61 from moving in the reverse fastening direction, e.g. from being released from the bolt portion 621, while facilitating fastening of the bolt portion 621 and the nut 61 to each other.

In the present embodiment, the nut 61 and the bolt portion 621 may have a right-hand thread. Thus, the first and second gripping portions 611 and 301 may be fastened by clockwise rotation of the nut 61 and may have a sawtooth structure to prevent releasing caused by counterclockwise rotation.

In an implementation, the nut 61 and the bolt portion 621 may have a left-hand thread. Thus, the first and second gripping portions 611 and 301 may be fastened by counterclockwise rotation of the nut 61 and may have a sawtooth structure to prevent releasing caused by clockwise rotation (not shown).

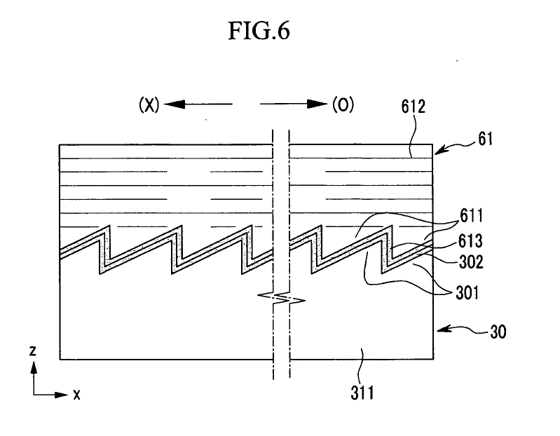

FIG. 6 illustrates a coupling state of the outer surface of the cap plate and the bottom of the nut of FIG. 3. For example, FIG. 6 illustrates a state in which the terminal hole 311 and the screw hole 612 of the nut 61 that penetrate or are aligned with each other are cut in a z-axis direction and inner surfaces thereof are spread in an x-axis direction.

Referring to FIG. 6, the first gripping portion 611 of the nut 61 may be sawtooth-coupled to or interengaged with the second gripping portion 301 of the cap plate 30. Therefore, the nut 61 having the first gripping portion 611 may rotate in a fastening direction (rightward arrow, O) to be fastened to the second gripping portion 301 and may be prevented from being rotated in a releasing direction (leftward arrow, X) by the second gripping portion 301.

Referring to FIG. 4, a first width W1 of each of the sawteeth of the first gripping portion 611 may be formed in a fan shape outside of the screw hole 612 of the nut 61 and a second width W2 of the sawteeth of the second gripping portion 301 may be formed in a fan shape outside of the terminal hole 311. Therefore, the first and second gripping portions 611 and 301 may be coupled to each other along the first and second widths W1 and W2 to have strong fastening force. Accordingly, it is possible to effectively prevent release or loosening of the nut 61 fastened to the bolt portion 621 of the electrode terminal 41.

Referring to FIG. 5, the second width W2 of the second gripping portion 301 in a radial direction thereof may be larger than the first width W1 of the first gripping portion 611 in a radial direction thereof, thereby effectively preventing release or loosening of the nut 61. For example, if the second width W2 of the second gripping portion 301 were to be smaller than the first width W1 of the first gripping portion 611, the first gripping portion 611 may deviate from the second gripping portion 301, e.g., may contact and may be supported on the outer surface of the cap plate 30. Thus, an effect of preventing the nut 61 from being released from the electrode terminal 41 may be deteriorated.

In accordance with the connection structure of the electrode assembly 10 and the electrode terminal 41, the electrode terminal 41 and the cap plate 30 may be electrically insulated from each other. For this, at least one of the first and second gripping portions 611 and 301 may have an insulation structure.

For example, a first insulating layer 613 may be formed on a surface (e.g., a bottom of the nut as illustrated in FIG. 6) of the first gripping portion 611 of the nut 61, e.g., the surface facing the outer surface of the cap plate 30. The bottom of the first gripping portion 611 of the first insulating layer 613 may be formed of, e.g., an anodized oxide layer or a coated synthetic resin layer.

Further, a second insulating layer 302 may be formed on a surface (e.g., a top of the cap plate as illustrated in FIG. 6) of the second gripping portion 301 of the cap plate 30, e.g., the surface facing the bottom of the nut 61. The top of the second gripping portion 301 of the second insulating layer 302 may be formed of, e.g., an anodized oxide layer or a coated synthetic resin layer.

As shown in FIG. 6, according to the present embodiment, the first insulating layer 613 may be formed on the first gripping portion 611 and the second insulating layer 302 may be formed on the second gripping portion 301 to improve reliability of an insulation structure between the outer surface of the cap plate 30 and the bottom of the nut 61.

Referring to FIG. 5, in the insulator 441, the cylindrical portion 451 may extend toward the second gripping portion 301; and a top of the cylindrical portion 451 may be formed in the same height as the second gripping portion 301, e.g., the top of the cylindrical portion 451 may be substantially coplanar with the second gripping portion 301. Therefore, when the nut 61 is fastened to the bolt portion 621, the first gripping portion 611 of the nut 61 may closely contact the second gripping portion 301 and the top of the cylindrical portion 451, e.g., may be coupled to the second gripping portion 301 and the top of the cylindrical portion 451.

The first insulting layer 613 on the first gripping portion 611 may closely contact the cylindrical portion 451 of the insulator 441 to form an electrical insulation structure. As a result, a sealing structure between the cylindrical portion 451 and the electrode terminal 41 may be further extended.

Referring to FIGS. 2 and 3, a side of the lead tabs 51 and 52 may be connected to the electrode terminals 41 and 42, respectively, and another side of the lead tabs 51 and 52 may be connected to the uncoated regions 111 and 121 on respective ends of the electrode assembly 10.

Hereinafter, other embodiments will be described. A repeated description of the same components as the previous embodiments will not be described; and different components from the previous embodiment will be described.

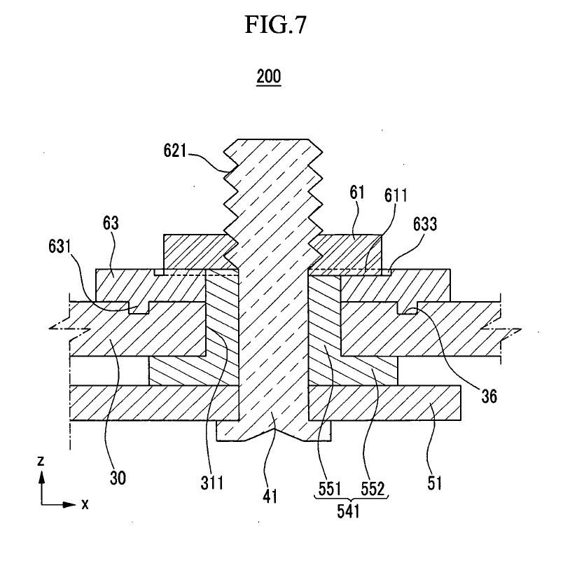

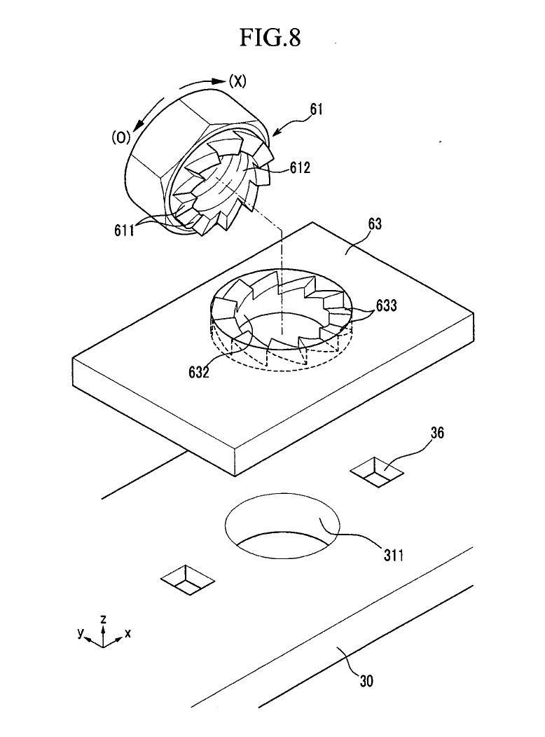

FIG. 7 illustrates a cross-sectional view of a coupling state of an electrode terminal, a cap plate, and a lead tab in a rechargeable battery according to another embodiment. FIG. 8 illustrates an enlarged perspective view of the cap plate, an outer surface of a top plate, and a bottom of a nut of FIG. 7.

Referring to FIGS. 7 and 8, the rechargeable battery 200 according to the present embodiment may further include a top plate 63 interposed between the outer surface of the cap plate 30 and the nut 61. The top plate 63 may be coupled to a rotation preventing groove 36 of the cap plate 30 by a protrusion 631. The top plate 63 may have a through-hole 632 in communication with, e.g., may be aligned with, the terminal hole 311.

In the rechargeable battery 100 according to the previous embodiment, the first and second gripping portions 611 and 301 may be formed on the nut 61 and the cap plate 30, respectively, to prevent release or loosening of the nut 61. In the rechargeable battery 200 according to the present embodiment, first and second gripping portions 611 and 633 may be on the nut 61 and the top plate 63, respectively, to prevent release or loosening of the nut 61.

For example, the top plate 63 may be mounted on the cap plate 30; and the second gripping portion 633 may be formed on an outer surface of the top plate 63 that faces the first gripping portion 611, at the time the top plate 63 is made. In comparison with the previous embodiment in which the second gripping portion 302 may be formed on the cap plate 30 having a complicated structure, in the present embodiment, the second gripping portion 633 may be formed on the additionally provided top plate 63, thereby facilitating formation of the second gripping portion 633 and the cap plate 30.

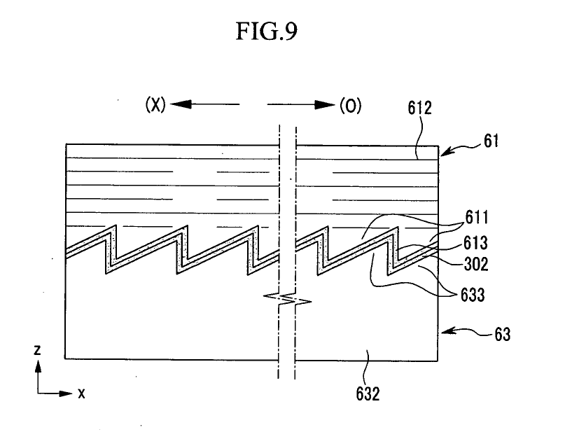

FIG. 9 illustrates a coupling state of the outer surface of the top plate and the bottom of the nut of FIG. 8. For example, FIG. 9 illustrates a state in which the through-hole 632 and the screw hole 612 of the nut 61 that penetrate and/or are aligned with each other are cut in a z-axis direction and inner surfaces thereof are spread in an x-axis direction.

Referring to FIG. 9, the first gripping portion 611 of the nut 61 may be sawtooth-coupled to, e.g., interengaged with, the second gripping portion 633 of the top plate 63. Therefore, the nut 61 with the first gripping portion 611 may rotate in a fastening direction (rightward arrow, O) to be fastened to the bolt portion 621 and may be prevented from being rotated in a releasing direction (leftward arrow, X), due to the coupling with the second gripping portion 633.

In an implementation, a first insulating layer 613 may be formed on a surface (e.g., a bottom of the nut as illustrated FIG. 9) of the first gripping portion 611 of the nut 61, e.g., the surface facing an outer surface of the top plate 63. The first insulating layer 613 may be formed of, e.g., an anodized oxide layer or a coated synthetic resin layer.

Further, a second insulating layer 302 may be formed on a surface (e.g., a top of the top plate as illustrated in FIG. 9) of the second gripping portion 633 of the top plate 63, e.g., the surface facing the bottom of the nut 61. The second insulating layer 633 may be formed of, e.g., an anodized oxide layer or a coated synthetic resin layer.

As shown in FIG. 9, according to the present embodiment, the first insulating layer 613 may be formed on the first gripping portion 611 and the second insulating layer 302 may be formed on the second gripping portion 633 to improve reliability of an insulation structure between the outer surface of the top plate 63 and the bottom of the nut 61.

Referring to FIG. 7, an insulator 541 may include a cylindrical portion 551 corresponding to the terminal hole 311 as well as a flange portion 552 that extends in a radial direction from the cylindrical portion 551. The cylindrical portion 551 may be interposed between an inner surface of the terminal hole 311 and an inner surface of a through-hole 632 and an outer surface of the electrode terminal 41 to electrically insulate the terminal hole 311 and the electrode terminal 41 from each other, and electrically insulate the through-hole 632 and the electrode terminal 41 from each other and seal them. The flange portion 552 may be interposed between an inner surface of the cap plate 30 and a top of the lead tab 51 to electrically insulate and seal both the cap plate 30 and the lead tab 51.

In the insulator 541, the cylindrical portion 551 may extend toward the second gripping portion 633 of the top plate 63; and a top of the cylindrical portion 551 may be formed in the same height as the second gripping portion 633, e.g., the top of the cylindrical portion may be substantially coplanar with the second gripping portion 633. Therefore, when the nut 61 is fastened to the bolt portion 621 of the electrode terminal 41, the first gripping portion 611 of the nut 61 may closely contact the second gripping portion 633 as well as the top of the cylindrical portion 551.

The first insulting layer 613 on the first gripping portion 611 may closely contact the cylindrical portion 551 of the insulator 541 to form an electrical insulation structure. As a result, a sealing structure between the cylindrical portion

The embodiments may help prevent rotation of the nut in the release direction on the bolt portion of the electrode terminal caused by elasticity of the gasket or the insulator. Thus, the fastening force between the electrode terminal and the nut may be improved.

The embodiments provide a rechargeable battery capable of preventing a weakening of the fastening force between an electrode terminal and a nut.

In particular, according to the embodiments, an electrode terminal may be installed in a terminal hole of a cap plate, and a first gripping portion may be formed on the surface of the nut coupled to the electrode terminal. The first gripping portion may be supported on the cap plate, thereby preventing rotation in a direction in which the nut is released.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A rechargeable battery, comprising:
an electrode assembly including a positive electrode and a negative electrode on surfaces of a separator;
a case accommodating the electrode assembly, the case including an opening at one end thereof;
a cap plate closing the opening of the case, the cap plate including a terminal hole therethrough;
an electrode terminal in the terminal hole of the cap plate; and
a nut screw-coupled to the electrode terminal outside of the case,
wherein the nut includes a first gripping portion extending toward the cap plate, the first gripping portion:
being configured to prevent releasing of the nut in a reversed fastening direction, and
being supported on the cap plate.

2. The rechargeable battery as claimed in claim 1, wherein the first gripping portion is on a surface of the nut, the surface facing the cap plate.

3. The rechargeable battery as claimed in claim 1, wherein the cap plate includes a second gripping portion on an outer surface thereof, the second gripping portion facing the first gripping portion.

4. The rechargeable battery as claimed in claim 3, wherein the first gripping portion and the second gripping portion each have an uneven structure, the uneven structure of the first gripping portion being coupled with the uneven structure of the second gripping portion.

5. The rechargeable battery as claimed in claim 3, wherein the first gripping portion and the second gripping portion each have a sawtooth structure, the sawtooth structure of the first gripping portion being coupled with the sawtooth structure of the second gripping portion.

6. The rechargeable battery as claimed in claim 5, wherein:
a first width of the sawtooth of the first gripping portion is formed in a fan shape outside of a screw hole of the nut, and
a second width of the sawtooth of the second gripping portion is formed in a fan shape outside of the terminal hole.

7. The rechargeable battery as claimed in claim 3, wherein the first gripping portion and the second gripping portion have complementary structures, the complementary structures of the first and second gripping portions being interengaged with one another.

8. The rechargeable battery as claimed in claim 3, wherein the first gripping portion has a first width in a radial direction thereof, the second gripping portion has a second width in a radial direction thereof, and the second width is greater than the first width.

9. The rechargeable battery as claimed in claim 3, wherein the first gripping portion includes a first insulating layer on a surface thereof that faces the second gripping portion, the first insulating layer including one of an anodized oxide layer or a coated synthetic resin layer.

10. The rechargeable battery as claimed in claim 3, wherein the second gripping portion includes a second insulating layer on a surface thereof that faces the first gripping portion, the second insulating layer including one of an anodized oxide layer or a coated synthetic resin layer.

11. The rechargeable battery as claimed in claim 3, further comprising an insulator in the terminal hole, wherein:
the insulator includes:
a cylindrical portion interposed between an inner surface of the terminal hole and the electrode terminal, and
a flange portion extending from the cylindrical portion and interposed between an inner surface of the cap plate and the lead tab,
a top of the cylindrical portion extends toward the second gripping portion, and
the first gripping portion is coupled to the second gripping portion and to the top of the cylindrical portion.

12. The rechargeable battery as claimed in claim 1, further comprising a top plate having a through-hole aligned with the terminal hole, the top plate being coupled to an outer surface of the cap plate and closely contacting the nut.

13. The rechargeable battery as claimed in claim 12, wherein the top plate includes a second gripping portion on an outer surface thereof, the second gripping portion facing the first gripping portion.

14. The rechargeable battery as claimed in claim 13, wherein the first gripping portion and the second gripping portion each have a sawtooth structure, the sawtooth structure of the first gripping portion being coupled with the sawtooth structure of the second gripping portion.

15. The rechargeable battery as claimed in claim 14, wherein:
a first width of the sawtooth of the first gripping portion is formed in a fan shape outside of a screw hole of the nut, and
a second width of the sawtooth of the second gripping portion is formed in a fan shape outside of the through-hole of the top plate.

16. The rechargeable battery as claimed in claim 13, wherein the first gripping portion and the second gripping portion have complementary structures, the complementary structures of the first and second gripping portions being interengaged with one another.

17. The rechargeable battery as claimed in claim 13, wherein the first gripping portion has a first width in a radial direction thereof, the second gripping portion has a second width in a radial direction thereof, and the second width is greater than the first width.

18. The rechargeable battery as claimed in claim 13, wherein the first gripping portion includes a first insulating layer on a surface thereof that faces the second gripping portion, the first insulating layer including one of an anodized oxide layer or a coated synthetic resin layer.

19. The rechargeable battery as claimed in claim 13, wherein the second gripping portion includes a second insulating layer on a surface thereof that faces the first gripping portion, the second insulating layer including one of an anodized oxide layer or a coated synthetic resin layer.

20. The rechargeable battery as claimed in claim 13, further comprising insulator in the terminal hole, wherein:
the insulator includes:
a cylindrical portion interposed between the electrode terminal and an inner surface of the terminal hole and between the electrode terminal and an inner surface of the through-hole of the top plate, and
a flange portion extending from the cylindrical portion and interposed between an inner surface of the cap plate and the lead tab,
a top of the cylindrical portion extends toward the second gripping portion, and
the first gripping portion is coupled to the second gripping portion and to the top of the cylindrical portion.
